(19) United States
(12) Patent Application Publication
(10) Pub. No.: US 2026/0235231 A1
(43) Pub. Date: Aug. 13, 2026

(54) Extensible Hose Device

(71) Applicant: Yuan Pin Industrial Co., Ltd., Changhua County (TW)

(72) Inventor: Ming-Chih Hsieh, Changhua County (TW)

(21) Appl. No.: 19/047,883

(22) Filed: Feb. 7, 2025

(51) Int. Cl. F16L 11/02

(52) U.S. Cl. CPC F16L 11/02

(57) ABSTRACT

A sun-resistant extensible hose device includes an extensible hose wrapped in a sleeve. The sleeve is a woven element includes elastic warps and two non-elastic wefts. The elastic warps extend parallel to an axis of the hose. The non-elastic wefts extend around the hose in right-hand and left-hand helixes respectively while intertwining with the elastic warps. Each of the elastic warps includes an elastic yarn and a non-elastic yarn extending around the elastic yarn in a helical manner.

### BACKGROUND OF INVENTION

### 1. FIELD OF INVENTION

The present invention relates to a hose device that is extensible due to rise in hydraulic pressure and, more particularly, to a sun-resistant extensible hose device.

### 2. RELATED PRIOR ART

For clarity of the following description, the term “extensible” refers to increase of size in an axial direction, and the term “expansible” refers to increase of size in both axial and radial directions. An extensible hose device includes an expansible elastic hose covered with a non-elastic woven sleeve. As the hose contracts, the sleeve also contracts axially, appearing to be wrinkled. Disadvantageously, the external diameter of the sleeve will increase, resulting in inconvenient contracting and unpleasant appearance. In addition, the wrinkles are prone to deformation and become weak points during repeated extension and contraction, which may lead to cracking. If the crack expands, it will affect the constriction of the hose, rendering the water hydraulic pressure uneven in the hose that increases the risk of bursting the hose under high hydraulic pressure.

Such extensible hose devices are usually used outdoors and rewound and placed outdoors after use. To dry such extensible hose devices, users tend to expose them to sunlight for long periods of time. Due to long-term exposure to ultraviolet light, such extensible hose devices age and embrittle which cause problems such as inadequate extension and contraction and entangling.

Therefore, the present invention is intended to obviate or at least alleviate the problems encountered in the prior art.

It is the primary objective of the present invention to provide a sun-resistant extensible hose device.

To achieve the foregoing objective, the sun-resistant extensible hose device includes an extensible hose wrapped in a sleeve. The sleeve is a woven element includes elastic warps and two non-elastic wefts. The elastic warps extend parallel to an axis of the hose. The non-elastic wefts extend around the hose in right-hand and left-hand helixes respectively while intertwining with the elastic warps. Each of the elastic warps includes an elastic yarn and a non-elastic yarn extending around the elastic yarn in a helical manner.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a sun-resistant extensible hose device according to the preferred embodiment of the present invention;

FIG. 2 is a side view of the hose device shown in FIG. 1;

FIG. 3 is a partial view of the hose device shown in FIG. 1;

FIG. 4 is another partial view of the hose device shown in FIG. 1; and

FIG. 5 is a side view of the hose device in another position than shown in FIG. 4.

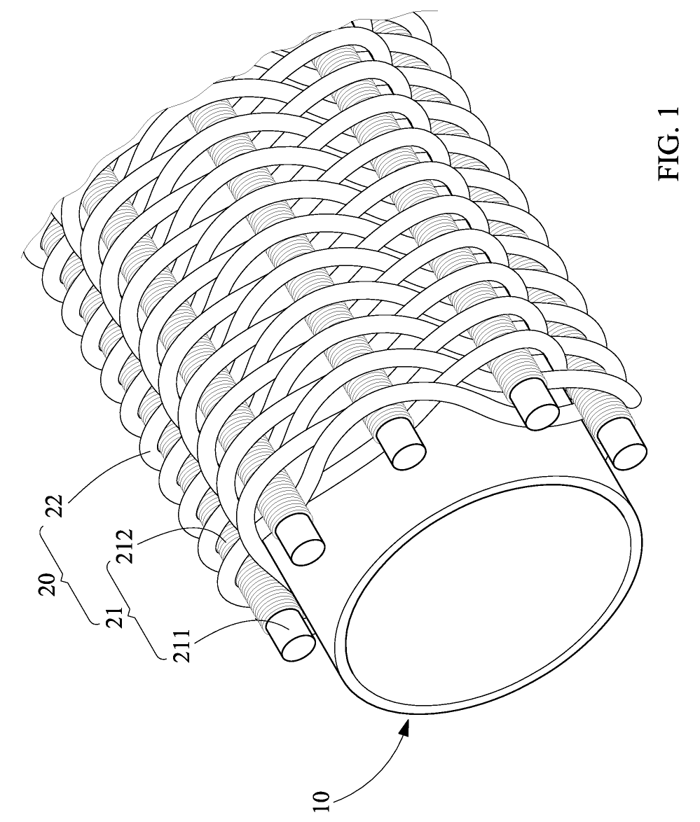

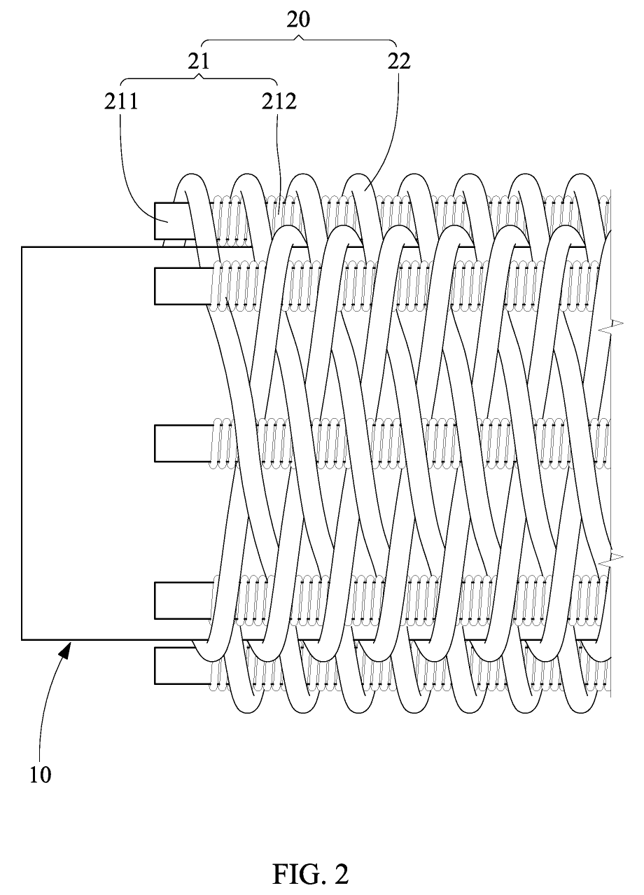

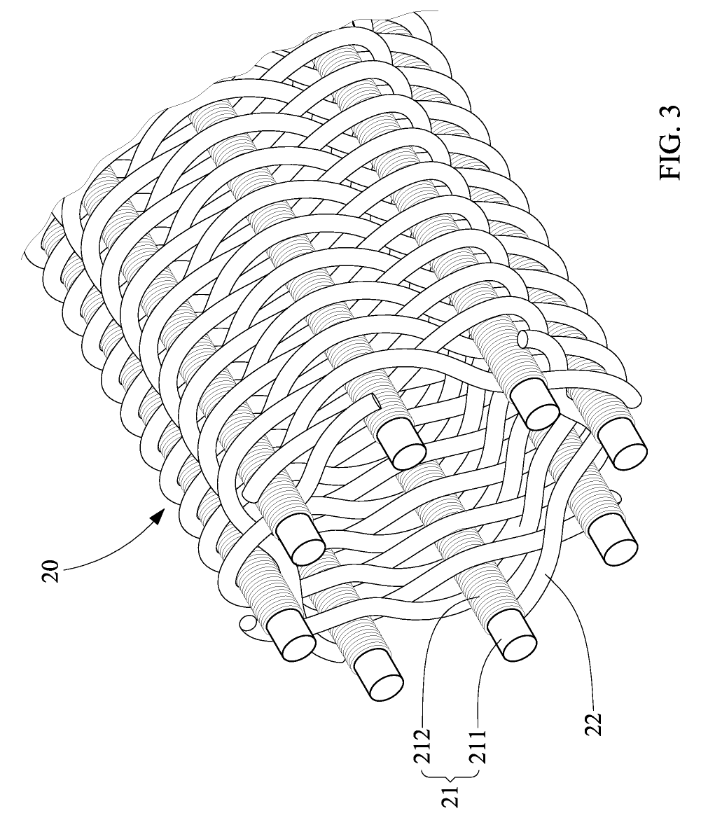

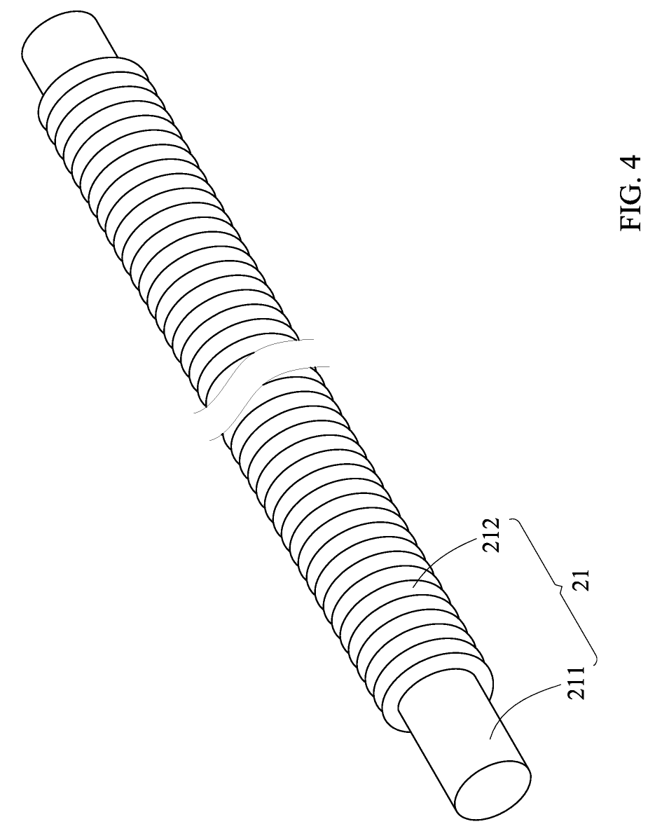

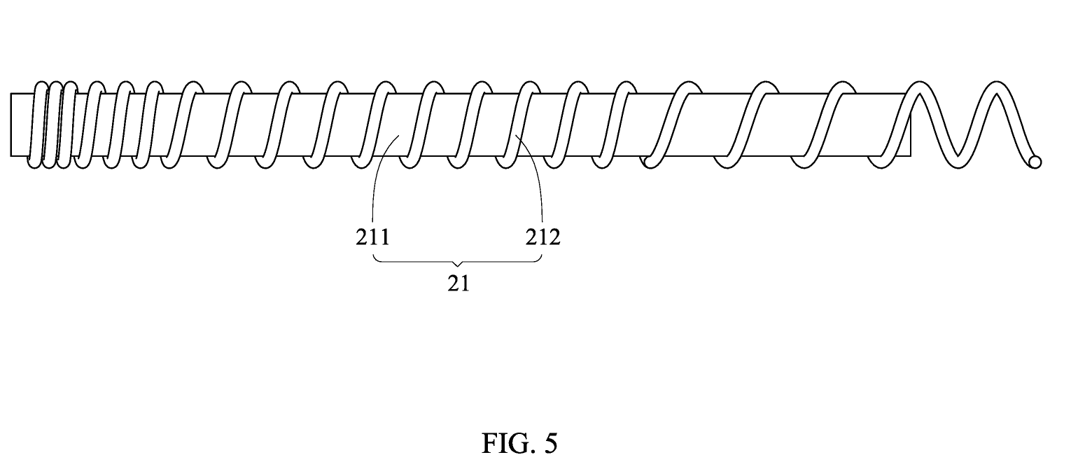

Referring to FIGS. 1 through 5, an extensible hose device includes a hose 10 wrapped in a sleeve 20 according to the preferred embodiment of the present invention.

The hose 10 is expansible and contractable in both axial and radial directions. The hose 10 is made of latex or thermoplastic elastomer (“TPE”) for example.

The sleeve 20 is a tubular woven element that wraps the hose 10. The sleeve 20 is movable relative to the hose 10.

Further, the sleeve 20 consists of elastic warps 21 and two non-elastic wefts 22. Each of the elastic warps 21 is parallel to an axis of the hose 10. The first non-elastic weft 22 extends around the hose 10 along a right-hand helix while the second non-elastic weft 22 extends around the hose 10 along a left-hand helix. Therefore, a section of the first non-elastic weft 22 extends on the one of the warps 21 while a corresponding section of the second non-elastic weft 22 extends beneath the same warp 21, and vice versa.

Each of the elastic warps 21 preferably consists of an elastic yarn 211 and a non-elastic yarn 212. The elastic yarn 211 is made with elasticity according to the intended expansion and contraction of the hose 10. The non-elastic yarn 212 extends around the elastic yarn 211 in a helical manner so that the former shields the latter from sunlight.

Alternatively, each of the elastic warps 21 consists of multiple elastic yarns 211 and multiple non-elastic yarns 212. The elastic yarns 21 extend parallel to one another or are intertwined or woven. The non-elastic yarns 212 extend parallel to one another or are intertwined or woven.

The hose 10 can axially expand and contract according to the presence or absence of hydraulic pressure in the hose 10. The sleeve 20 exerts a radial binding force on the hose 10, thereby confining the expansion and contraction of the hose 10 in a reasonable range. In addition, the use of the elastic warps 21 allows the sleeve 20 to comply to the hose 10 during extension and contraction.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. An extensible hose device comprising an extensible hose (10) and a sleeve (20) for wrapping the hose (10);
wherein the sleeve (20) is a woven element comprising elastic warps (21) and two non-elastic wefts (22);
wherein the elastic warps (21) extend parallel to an axis of the hose (10);
wherein the non-elastic wefts (22) extending around the hose (10) along right-hand and left-hand helixes respectively while intertwining with the elastic warps (21);
wherein each of the elastic warps (21) comprises an elastic yarn (211) and a non-elastic yarn (212) extending around the elastic yarn (211) in a helical manner.
